(19) United States
(12) Patent Application Publication
(10) Pub. No.: US 2009/0137284 A1
(43) Pub. Date: May 28, 2009

(54) Method and System for Enabling a Toy Mode on a Telephone

(76) Inventor: Vipula Liyanaarachchi, Battaramulla (LK)

Correspondence Address: Fay Kaplun & Marcin, LLP/ Motorola, 150 Broadway Suite 702, New York, NY, 10038, US

(21) Appl. No.: 11/946,518

(22) Filed: Nov. 28, 2007

(51) Int. Cl. H04B 1/38; H04M 1/00

(52) U.S. Cl. 455/567; 455/550.1

(57) ABSTRACT

Described are a method, a communication device, and a system for enabling a toy mode on a telephone. The method includes operating a device in a first operating mode, the first operating mode being a full functional mode, receiving a selection for a second operating mode while the device is operating in the first operating mode, the second operating mode being a reduced function mode, and configuring the device to operate in the second operating mode, wherein the configuration includes altering an operation of a communication interface of the device. The communication device includes a communication interface, a memory storing a plurality of operating profiles in an updatable database, each operating profile including at least one setting of the communication device, and a processor receiving a selection of an operating mode corresponding to one of the operating profiles, and configuring the at least one setting of the communication device to convert the communication device to the selected operating mode, the selected operating mode being a reduced communication function mode.

### FIELD OF INVENTION

The present application generally relates to systems and methods for enabling a toy mode on a telephone. Specifically, the system and methods may allow a user of a device, such as a hand-held mobile phone or a landline phone, to convert the device from operating in a standard mode to operating in toy mode, thereby disabling or reducing specific functionalities of the standard mode.

### BACKGROUND

Small children, by nature, like to imitate adults and as such, may pick up a telephone and begin dialing numbers at random. If the number is an actual number, an actual telephone call will be placed, which may result in accrued phone changes, minute usage, etc. In addition, it may create a nuisance call to an unknowing third-party recipient of the call. With technological advancements, many of the current phones have very user-friendly displays, such as touch screen displays, and easily accessible address books via one-touch dialing and voice command dialing. Therefore, the chances of a child inadvertently dialing an actual phone number while playing with the phone have greatly increased as the usability improves.

While parents may utilize phone-locking mechanism (e.g., via keypad lock, etc.), this may make the child unhappy and may possibly result in the child damaging the phone due to frustration and/or attempts to unlock the phone. On the other hand, a locked phone may encourage a curious child to seek the unlocking mechanism, thereby likely defeating the purpose of the lock. Another alternative is to provide the child with an imitation phone. In fact, there are many imitation phones in the market, however it is difficult to deceive today's children with such imitations. Specifically, a child may realize that that the imitation phone is less sophisticated than an actual, usable phone. Thus, the child may naturally gravitate toward a more realistic phone and wish to play with the same phone that the parents are using.

### SUMMARY OF THE INVENTION

The present invention relates to a method, a communication device, and a system for enabling a toy mode on a telephone. The method includes operating a device in a first operating mode, the first operating mode being a full functional mode, receiving a selection for a second operating mode while the device is operating in the first operating mode, the second operating mode being a reduced function mode, and configuring the device to operate in the second operating mode, wherein the configuration includes altering an operation of a communication interface of the device. The communication device includes a communication interface, a memory storing a plurality of operating profiles in an updatable database, each operating profile including at least one setting of the communication device, and a processor receiving a selection of an operating mode corresponding to one of the operating profiles, and configuring at least one setting of the communication device to convert the communication device to the selected operating mode, the selected operating mode being a reduced communication function mode.

### BRIEF DESCRIPTION OF THE DRAWINGS

FIG. 1 shows an exemplary system for activating a toy mode on an electronic device, such as mobile unit (“MU”) according to the present invention.

FIG. 2 shows an exemplary method for converting a device, such as the MU of FIG. 1, from operating in a standard mode to operating in toy mode according to the exemplary embodiments of the present invention.

FIG. 3 shows an exemplary method for activating/disabling specific applications and functionalities of an MU as the MU converts from the standard mode to operating in toy mode according to the exemplary embodiments of the present invention.

### DETAILED DESCRIPTION

The present invention may be further understood with reference to the following description of exemplary embodiments and the related appended drawings, wherein like elements are provided with the same reference numerals. The exemplary embodiments are related to systems and methods for enabling a toy mode on a telephone. Specifically, the exemplary systems and methods may allow a user of a device, such as a hand-held mobile phone or a landline phone, to convert the device from operating in a standard mode to operating in a toy mode, thereby disabling or reducing specific functionalities of the standard mode. In other words, the device may contain multiple profiles (e.g., a toy profile, a standard profile, etc.), wherein the settings and the functionality of various device components may depend on a profile selected by a user. The toy profile for the device may disable or reduce the function of specific components of the device, while the standard profile allows for normal, unrestricted operation of the device. The exemplary embodiments of the present invention may be easily implemented into a device using the existing user interface software components and small modifications to a radio driver software layer. Accordingly, there is no need for additional hardware resources to be in operation.

The toy mode may allow certain aspects of the phone to act similar to the standard mode, such as ring tones, displayed graphics and pictures, games, contact listings, etc. However, while in the toy mode, any changes made to these aspects may not be reflected or be applied on the device after exiting the toy mode and returning to standard mode. Furthermore, no (or limited) calls or other communication (e.g., text messages, e-mail, etc.) may be placed from the device while the device is set to toy mode. Specifically, one embodiment may disable a communication interface, such as an antenna or a communication transceiver, on the device, thereby preventing any calls from being placed. While another embodiment may allow for limited calls to designated number (e.g., parental contact numbers, etc.) while preventing communication to any other destinations. In addition, it should be noted that the toy mode may not make the subscriber line busy. Thus, incoming calls may be received, forwarded to another destination, and/or directed to a voicemail system.

As will be described in great detail below, the device may continue to receive actual phone calls (or other forms of communication) while the device is in the toy mode. While the exemplary systems and method described herein may refer to the device as a mobile phone, the devices according to the exemplary embodiments of the present invention may include devices such as voice over IP (“VoIP”) telephone receivers, personal digital assistants (“PDAs”), Fixed Wireless Terminals (“FWTs”), smartphones, laptop computers, and any other electronic devices. FWTs may be described as terminals (e.g., stationary desktop telephones) that utilize radio based telecommunications technologies to connect with a network, whereby the FTWs may be limited to a substantially permanent location, with little to no roaming abilities.

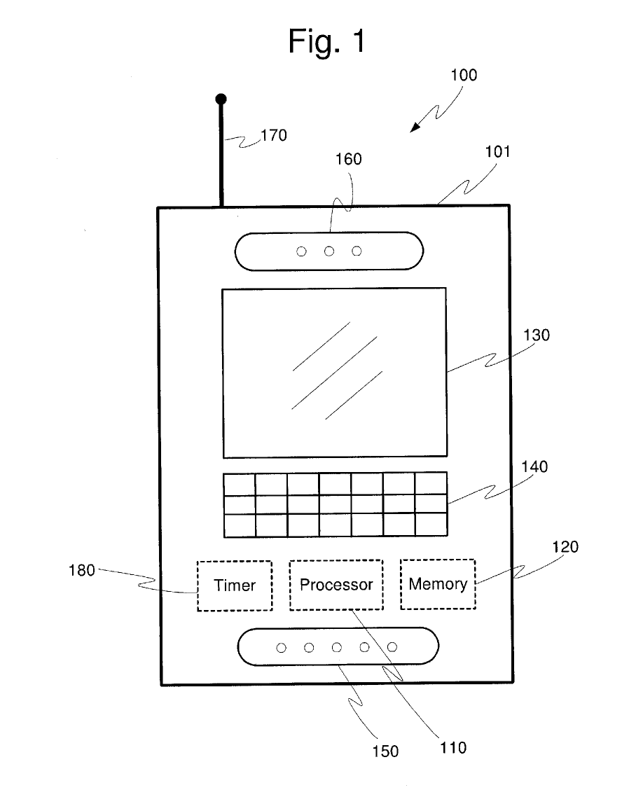

FIG. 1 shows an exemplary system 100 for activating a toy mode on an electronic device, such as mobile unit (“MU”) 101, according to the exemplary embodiments of the present invention. According to the exemplary embodiment, FIG. 1 shows a block diagram view of the handheld MU 101 (e.g., a wireless telephone) according to the present invention. The MU 101 may include a processor 110, a memory 120, a display screen 130, a keypad 140, a microphone 150, a speaker 160, an antenna 170, and a timer 180. The processor 110 may regulate the operation of the MU 101 by facilitating communications between the various components such as the memory 120, the display screen 130, the keypad 140, etc.

According to an exemplary embodiment of the present invention, the processor 160 may regulate the operation of the MU 101 by facilitating the communications between the various components of the MU 101. For example, the processor 160 may include a microprocessor, an embedded controller, a further application-specific integrated circuit, a programmable logic array, etc. The processor 160 may perform data processing, execute instructions and direct a flow of data between components coupled to the processor 160 (e.g., the memory 120, the display screen 130, the keypad 140, etc.). As will be explained below, the exemplary processor 160 may receive instructions from a user to switch operating mode from the standard mode to the toy mode, and vice versa.

As will be described in greater detail below, the user of the MU 101 may switch from the standard mode to the toy mode by inputting a special key sequence on the keypad 140. It should be noted that the activation key sequence may be a short, simple sequence (e.g., one similar to a keypad lock sequence). Therefore, switching from the standard mode to the toy mode may be performed relatively quickly by the user. Accordingly, it may not necessarily be a pass code, as no security needed. The switching from the toy mode back to the standard mode may require a further special key sequence. The further special key sequence may be a difficult to guess key combination, such as a passcode. This passcode may be known only to the user (e.g., unknown to the child) and may also be used by the user to switch from the toy mode back to the standard mode. Thus, a child may be prevented from switching the MU 101 from the toy mode to standard mode without the knowing the passcode. However, in the event that the MU 101 receives an actual phone call while the MU 101 is in toy mode, the user may enter a further special key sequence to accept the call. If the child is capable of (and permitted to) answer phone calls from the MU 101 while the MU 101 is in toy mode, the further special key sequence, such as an “answer code”, may be set to a single key that may only be active (or available) during an incoming call. In addition to the passcode, this answer code may be a selection within a settings tab of a graphical user interface (“GUI”) of the display screen 130. Alternatively, the MU 101 may include a physical switch for switching between different operating modes. For example, the physical switch may be hidden from plain view (e.g., in a battery compartment) to prevent the child from switching the MU 101 from the toy mode to the standard mode.

According to the exemplary embodiments of the present invention, the memory 120 may be any storage medium capable of being read from and/or written to by the processor 110, or another processing device within the MU 101. The memory 120 may include any combination of volatile and/or nonvolatile memory (e.g., RAM, ROM, EPROM, Flash, etc.) The memory 120 may also include one or more storage disks such as a hard drive. According to one embodiment of the present invention, the memory 120 may be a temporary memory in which data may be temporarily stored until it is transferred to a permanent storage location (e.g., uploaded to a personal computer). In another embodiment, the memory 120 may be a permanent memory comprising an updateable database.

Furthermore, it should be noted that each of the settings and functionalities for specific components of the MU 101 may be stored in the memory 120. In other words, each of the different operating modes of the MU 101 may utilize distinct settings and functionalities from other operating modes. Any changes made to the settings while the MU 101 is in a first operating mode (e.g., the standard mode) may not apply when the MU 101 is switched to a second operating mode (e.g., the toy mode). For example, the memory 120 may include specific profiles, such as a toy profile or a standard profile, which may be referred to by the processor 110 based on the current operation mode of the MU 101. In addition, the memory 120 may include a contact listing database (e.g., a phone book), image/video data, applications such as games, etc. Certain portions of the content within the memory 120 may continue to be available to the user of the MU 101 while the MU 101 is operating the toy mode. For example, games may continue to be accessible for use while the MU 101 is operating in the toy mode. In addition, a limited phone book may be accessible to a child while the MU 101 is in the toy mode, wherein the limited phone book may allow for only selected number to be dialed (if the MU 101 is able to place limited calls while in the toy mode).

According to the exemplary embodiment of the present invention, the antenna 170 may be in communication with the processor 110 via a transceiver (not shown) and may transmit communication data between the MU 101 and a communication network. Optionally, the user may disable the antenna 170 when the user places the phone in toy mode. Specifically, in the context of mobile devices (e.g., cellular telephones), a user may wish to disable the antenna 170 to eliminate any radiation risk associated with a child's prolonged usage of the MU 101. Furthermore, by disabling the antenna 170, the user may prevent inadvertent calls (or any other form of communication) from being placed from the MU 101 while a child plays with the MU 101. Alternatively, the antenna 170 may remain active while the MU 101 is operating in the toy mode. According to this alternative embodiment, a call may not be placed (or only limited calls may be placed) while the MU 101 is in the toy mode, however the MU 101 may continue to receive incoming calls. For example, in the exemplary embodiments where the MU 101 is a mobile phone, the MU 101 may receive incoming calls while in the toy mode and automatically direct the call to a voicemail box or automatically forward the incoming call to another destination (e.g., another phone number, a personal computer, a PDA, etc.). In another example, any incoming calls may trigger a distinctive ringtone, which may alert the user (e.g., owner) that the MU 101 is receiving an actual call while the MU 101 is in the toy mode. The limitations of outgoing and incoming calls will be described in greater detail below.

As described above, the exemplary MU 101 may be described as a mobile phone. However, it should be noted that the incorporation of an antenna on an exemplary devices according to alternative embodiments of the present invention may be omitted. For example, in the event the device is a landline telephone, there may not be an antenna on the device. Thus, the above-mentioned functionalities of the antenna 170 may not apply to such an embodiment. It should be noted that if the device is a landline telephone, the toy mode settings may prevent the subscriber line from being busy. Even if the receiver of the landline telephone is off of its cradle, the phone line may remain available for incoming calls.

According to one exemplary embodiment of the present invention, the MU 101 may include a timer 180. The timer 180 may be used to automatically switch the operating mode of the MU 101 upon the expiration of a predetermined time during inactivity. For example, the MU 101 may be placed in the toy mode prior to handing the MU 101 to a child. As the child plays with the MU 101, the child may interact with the MU 101 via the keypad 140. However, when child stops playing with the MU 101 (e.g., fails to press a key), the timer 180 may begin to count. If the timer 180 is set to 30 minutes, the MU 101 may switch from the toy mode to the standard mode at the expiration of 30 minutes. Accordingly, the MU 101 is able to automatically return to the standard mode once the child is finished playing with the MU 101.

Alternatively, or additionally, the MU 101 may be programmed to automatically switch from the standard mode to the toy mode after a prolonged period of inactivity. In other word, if the user of the MU 101 steps away from the MU 101, the processor 110 of the MU 101 may automatically switch the operating mode to toy mode. By placing the MU 101 in toy mode, a child may be prevented from placing an inadvertent call while the user is away from the MU 101. Thus, the child may continue to play with the MU 101 if the MU 101 was left in an accessible location for a period of time, and there may be no risk of transmitting any form of communication (or only transmitting limited communications) from the MU 101 as the child plays with the MU 101.

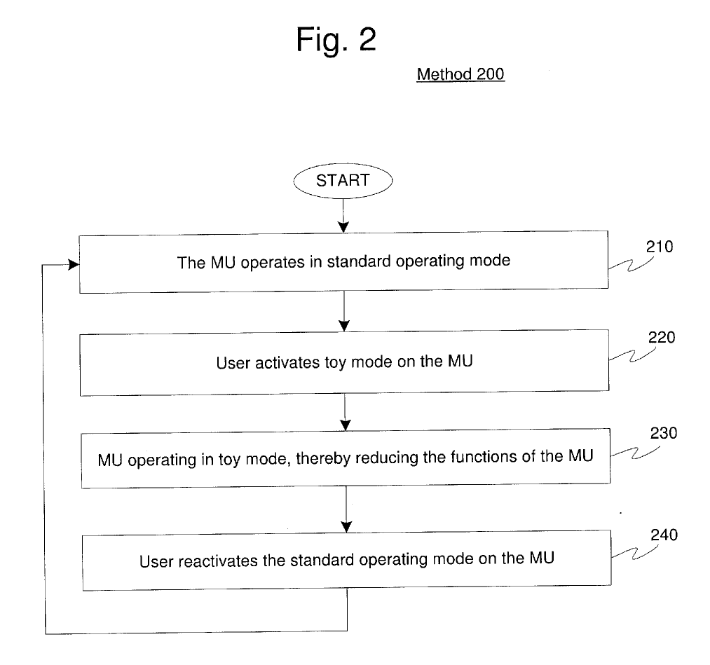

FIG. 2 shows an exemplary method 200 for converting a device, such as the MU 101, from operating in a standard mode to operating in toy mode according to the exemplary embodiments of the present invention. The exemplary method 200 will be described with reference to the exemplary system 100 of FIG. 1. As described above, the exemplary MU 101 may be a device such as a mobile phone. Alternatively, the exemplary embodiments of the present invention may apply to other devices, such as fixed landlines, cordless phones, FWTs, PDAs, laptop computers, etc.

In step 210, the MU 101 may initially operate in a standard mode. While in standard mode, the processor 110 may instruct the MU 101 to function for normal operation, wherein incoming and outgoing communications (e.g., phone calls, text messages, email) may continue to be transmitted and received by the MU 101 (e.g., via a communication interface, such as the antenna 170). Furthermore, any changes applied to the settings by the user may be stored in the memory 120. For example, additions/deletions made to a contact listing, changes to the display theme, addition/removal of any files (e.g., software applications, video files, image files, music files, ringtones, etc.) may be stored in the memory 120.

As described above, the user (e.g., a parent) of the MU 101 may switch the operating mode from the standard mode to the toy mode prior to allowing a child to play with the MU 101. Specifically, in step 220, the user may activate the toy mode on the MU 101. The user of the MU 101 may activate the toy mode by pressing a designated key or a special sequence of keys on the keypad 140. Alternatively, the activation may be a physical switch located in the MU 101. According to one embodiment of the present invention, the activation of the toy mode may be preformed automatically by the processor 110. As described above, the MU 101 may include a timer 180. The timer 180 may measure a duration of inactivity (e.g., idle time) for a predetermined period of time. For example, if the MU 101 is idle for the duration of the predetermined period, the processor 110 may automatically switch from the standard mode to the toy mode. Therefore, if a child is able to access the MU 101 without the user's knowledge (e.g., the user steps away from the MU 101), the MU 101 may “self-switch” to toy mode, thereby preventing inadvertent communications from being placed by the child.

In step 230, the MU 101 may operate in toy mode. While the MU 101 is in the toy mode, the MU 101 may operate in a similar manner to the standard mode. However, the placement of outgoing communication from the MU 101 may be disabled. In other words, if the child dials a number on the keypad 140 and attempts to initiate a phone call, all calls placed by the MU 101 in the toy mode may be ineffective (e.g., dummy calls). Accordingly, no call will take place, thereby avoiding any potential toll charges and/or call-time minute usage on the MU 101. Furthermore, the would-be recipient of the attempted phone call would not be bothered by the call placed by the child, thereby avoiding a potential nuisance call from the MU 101.

Furthermore, while the MU 101 is operating in toy mode, any display menus, ringtones, images, game, etc. may be active. However, any changes made by the child may not be reflected on the MU 101 after processor 110 exits the toy mode and returns to the standard mode. According to one exemplary embodiment of the present invention, the memory 120 of the MU 101 may include contact listing (e.g., phone book) customized for the child and prerecorded messages for the child to listen to while the MU 101 is operating in the toy mode. The contact listing may include persons, personas, characters, animals, etc. For example, the customized phone book may list one or more popular characters recognizable to the child and corresponding images representing each of the character displayable on the display screen 130. The child may select one of the characters to “call” from the MU 101, wherein the selection of a specific character may trigger a corresponding prerecorded message (e.g., audio file, video file) featuring the voice and/or image of the character for the child's amusement. In addition, while the MU 101 is operating in the toy mode, the processor 110 of the MU 101 may occasionally (e.g., at random intervals) simulate an incoming “call” from one of the characters in the customized phone book. The simulated call may trigger a distinctive ringtone playable through the speaker 160 and display an image/video of the character on the display screen 130. When the child presses a key on the keypad 140, the processor 110 may activate the prerecorded message corresponding to the character.

As described above, while the MU 101 is operating in the toy mode, the MU 101, according to one embodiment of the present invention, may continue to receive actual incoming communications (e.g., phone calls, text messages, etc.). The incoming communication may activate a distinctive ringtone identifying the communication as being valid (e.g., intended for the user of the MU 101, not the child). Alternatively, the incoming communication may be forwarded to another device (e.g., alternate phone, computer, etc.), or may be directed to a voicemail system accessible to the user. Accordingly, the user of the MU 101 may continue to receive communication when a child plays with the MU 101 while operating in toy mode.

In step 240, the user (e.g., a parent) of the MU 101 may switch the operating mode from the toy mode back to the standard mode prior to allowing the MU 101 to function normally. Similar to the activation of the toy mode, the user of the MU 101 may activate the standard mode by pressing the designated key or the special sequence of keys on the keypad 140. Alternatively, the activation may be a physical switch located in the MU 101. According to one embodiment of the present invention, the activation of the standard mode may be preformed automatically by the processor 110. As described above in reference to the toy mode, the timer 180 may measure a duration of inactivity (e.g., idle time) for a predetermined period of time. Accordingly, if the MU 101 is idle for the duration of the predetermined period, the processor 110 may automatically switch from the toy mode back to the standard mode. Therefore, if a child stops playing with the MU 101 for an extended period of time, the MU 101 may “self-switch” to standard mode. Regardless of the manner in which the operating mode is switched back to the standard mode, the method 200 may return to step 210 upon a switch from toy mode to standard mode, thereby allowing the method 200 to repeat as the operating mode is switched between standard mode and toy mode.

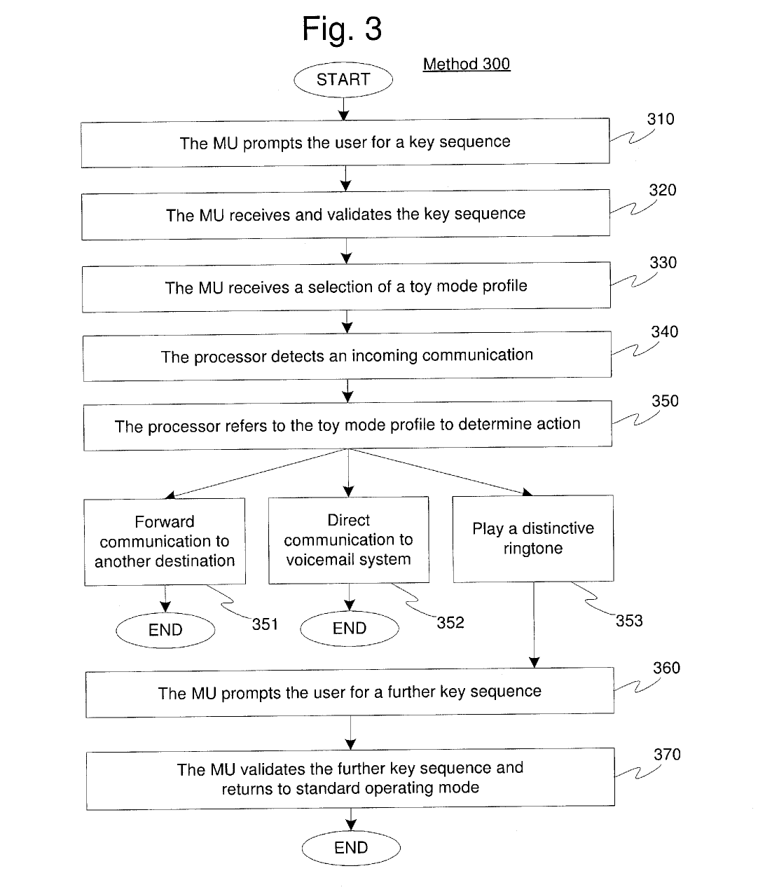

FIG. 3 shows an exemplary method 300 for activating/disabling specific applications and functionalities of the MU 101 as the MU 101 converts from the standard mode to operating in toy mode according to the exemplary embodiments of the present invention. According to the exemplary embodiments of the present invention, the method 300 may allow the MU 101 to operate according to different profiles within the memory 120 of the MU 101. These profiles, as described above, may include a standard mode operating profile and a plurality of toy mode operating profiles. Furthermore, any transitions between the operating profiles may require the user to enter a valid pass code, or a key sequence.

In step 310, the MU 101 may prompt the user for a key sequence to enter into the toy mode. As described above, the key sequence may be a code that may allow the user of the MU 101 to change the current operating mode. The key sequence may be treated as secret authentication data used to control access to the MU 101. Accordingly, the activation of the toy mode may provide limited usage to the MU 101 to a person other that the user, such as a child. As described above, entering the toy mode of the MU 101 may be a fast and easy task, however, exiting back to the standard mode for normal operation may be difficult. For example, returning back to the standard mode may require a long, preset key sequence with a time out or a menu item requesting a pass code.

In step 320, the MU 101 may receive the key sequence from the user and the processor 110 may validate the key sequence. If the processor 110 is able to validate the key sequence, the method 300 may continue to step 330. However, if the processor 110 is unable to validate the key sequence, the method 300 may return to step 310.

In step 330, the MU 101 may receive a selection of one of the toy mode profiles from the user. Specifically, the processor 110 may display the choices of toy profiles available for the MU 101 and access the selected toy mode profile from the memory 120. Each of the toy mode profiles may indicate distinctive setting preferences, such as display themes and instructions on handling incoming calls. Accordingly, a different toy mode profile may be activated depending on the specific child that will be playing with the MU 101. For example, a first child may have a toy mode profile having a display theme designed for a girl, while a second child may have a toy mode profile having a display theme designed for a boy. Other variations may allow the user (or the child) to further customize the display theme, ringtones, as well as other settings, and stored the settings within a corresponding toy mode profile.

Furthermore, it should be noted that each of the toy mode profiles may instruct the processor 110 as to how the MU 101 should function while operating in the selected toy mode. Specifically, one of the toy modes may deactivate a communication interface, thereby preventing the receipt of any incoming communication. Accordingly, the MU 101 with the deactivated communication interface may appear similar to a powered-off device from the prospective of another device (e.g., an outside caller). Other toy mode profiles may keep the communication interface active while using various methods for handling incoming calls. As described above, an incoming call may be forwarded to another device, may be directed to a voicemail system, or may trigger a distinctive ringtone to notify the user of the incoming call.

Assuming that the communication interface remains active while the MU 101 is in the toy mode, in step 340, the processor 110 may detect whether the MU 101 is receiving an incoming communication (e.g., call, text message, etc.). In step 350, the processor 110 may refer to the toy mode profile from the memory 120 to determine how the incoming call should be handled. For example, in step 351, the processor 110 may forward the communication to a predetermined destination (e.g., another phone number, a personal computer, a PDA, etc.). Alternatively, in step 352, the processor 110 may direct the communication to a voicemail system. In a further alternative, in step 353, the processor 110 may instruct the speaker 160 to play a distinctive ringtone indicating to the user that the MU 101 is currently receiving a valid incoming communication. Following step 353, the method 300 may continue to step 360.

In step 360, the MU 101 may prompt the user for a further key sequence to exit from the toy mode. While, the further key sequence may be the same key sequence referred to in step 310, it should be noted that the further key sequence may be a longer and more difficult sequence for deactivating the toy mode than the key sequence used for activating the toy mode. Similar to step 320 for transitioning from the standard mode to the toy mode, the MU 101, in step 370, may receive the further key sequence from the user and the processor 110 may validate the further key sequence in order to transition the MU 101 back to the standard mode. If the processor 110 is able to validate the further key sequence, the MU 101 returns to standard mode, wherein the settings and functionality of the MU 101 returns to normal operation. However, if the processor 110 is unable to validate the further key sequence, the method 300 may return to step 330 and continue to operate in the toy mode.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A method, comprising:
operating a device in a first operating mode, the first operating mode being a full functional mode;
receiving a selection for a second operating mode while the device is operating in the first operating mode, the second operating mode being a reduced function mode; and
configuring the device to operate in the second operating mode, wherein the configuration includes altering an operation of a communication interface of the device.

2. The method according to claim 1, further comprising:
deactivating the communication interface while the device is operating in the second operating mode.

3. The method according to claim 1, further comprising:
playing a distinctive ringtone when a communication is received while the device is operating in the second operating mode, wherein the ringtone indicates a receipt of a valid communication.

4. The method according to claim 1, further comprising:
forwarding a communication received via the communication interface to a destination while the device is operating in the second operating mode.

5. The method according to claim 4, wherein the destination is one of a voicemail system, a mobile telephone, a fixed wireless terminal, a personal digital assistant, a computer, a voice over internet protocol line, and a plain old telephone service line.

6. The method according to claim 1, further comprising:
receiving a passcode for activating the selection of the second operating mode while the device is operating in the first operating mode.

7. The method according to claim 1, further comprising:
receiving a selection of a contact from a contact listing while the device is operating in the second operating mode, wherein the contact is one of a person, a persona, a character, and an animal; and
playing a prerecorded message relating to the selected contact.

8. The method according to claim 1, further comprising:
playing a distinctive ringtone when a communication is received while the device is operating in the second operating mode, wherein the ringtone is related to a contact from a contact listing, the contact being one of a person, a persona, a character, and an animal; and
playing a prerecorded message relating to the selected contact.

9. A communication device, comprising:
a communication interface;
a memory storing a plurality of operating profiles in an updatable database, each operating profile including at least one setting of the communication device; and
a processor receiving a selection of an operating mode corresponding to one of the operating profiles, and configuring the at least one setting of the communication device to convert the communication device to the selected operating mode, the selected operating mode being a reduced communication function mode.

10. The communication device according to claim 9, wherein the processor is configured to deactivate the communication interface on the communication device while the communication device is operating in the selected operating mode.

11. The communication device according to claim 9, wherein the processor is configured to play a distinctive ringtone when a communication is received while the communication device is operating in the selected operating mode, wherein the ringtone indicates a receipt of a valid communication.

12. The communication device according to claim 9, wherein the processor is configured to forward a communication received via the communication interface to a destination while the communication device is operating in the selected operating mode.

13. The communication device according to claim 12, wherein the destination is one of a voicemail system, a mobile telephone, a fixed wireless terminal, a personal digital assistant, a computer, a voice over internet protocol line, and a plain old telephone service line.

14. The communication device according to claim 9, wherein the processor is configured to receive a passcode for activating the selected operating mode.

15. The communication device according to claim 9, wherein the processor is configured to receive a selection of a contact from a contact listing while the communication device is operating in the selected operating mode, wherein the contact is one of a person, a persona, a character, and an animal, the processor being further configured to play a prerecorded message relating to the selected contact.

16. The communication device according to claim 9, wherein, when a communication is received while the communication device is operating in the selected operating mode, predetermined audio data is executed by the processor, the predetermined audio data being corresponding to a contact from a contact listing, the contact being one of a person, a persona, a character, and an animal, the predetermined audio data including at least one of a ringtone and a prerecorded voice message.

17. A system, comprising:
a receiving means receiving a selection for an alternate operating mode on a communication device while the communication device is operating in a standard operating mode, the communication device including at least one setting and a communication interface;
a configuration means configuring the at least one setting on the communication device in order to convert the communication device into a toy.

18. The system according to claim 17, further comprising:
a deactivation means deactivating the communication interface on the communication device while the communication device is operating in the alternate operating mode.

19. The system according to claim 17, further comprising:
a playback means playing a distinctive ringtone when a communication is received while the communication device is operating in the alternate operating mode, wherein the ringtone indicates a receipt of a valid communication.

20. The system according to claim 17, further comprising:
a forwarding means forwarding a communication received via the communication interface to a destination while the communication device is operating in the alternate operating mode.

22. The system according to claim 17, further comprising:
a passcode receiving means receiving a passcode for activating the selection of the alternative operating mode while the communication device is operating in the standard operating mode.

23. The system according to claim 17, further comprising:
a contact receive means receiving a selection of a contact from a contact listing while the communication device is operating in the alternate operating mode, wherein the contact is one of a person, a persona, a character, an animal; and
a playback means playing a prerecorded message relating to the selected contact.

24. The system according to claim 17, wherein, when a communication is received while the communication device is operating in the alternate operating mode, predetermined audio data is executed by a playback means, the predetermined audio data being corresponding to a contact from a contact listing, the contact being one of a person, a persona, a character, and an animal, the predetermined audio data including at least one of a ringtone and a prerecorded voice message.
